(19) United States
(12) Patent Application Publication
(10) Pub. No.: US 2017/0072824 A1
(43) Pub. Date: Mar. 16, 2017

(54) BEVERAGE CUP HOLDER CONVERTIBLE TO SELF-VENTING ASH TRAY

(71) Applicant: FORD GLOBAL TECHNOLOGIES, LLC, Dearborn, MI (US)

(72) Inventors: David Huelke, Milan, MI (US); Eric Axel Smitterberg, Berkley, MI (US)

(21) Appl. No.: 14/850,306

(22) Filed: Sep. 10, 2015

(51) Int. Cl. B60N 3/08; B60Q 3/02; B60N 3/10

(52) U.S. Cl. CPC B60N 3/086; B60N 3/10; B60Q 3/0243; B60Q 3/0236

(57) ABSTRACT

A beverage cup holder is provided. That beverage cup holder is convertible to a self-venting ash tray. The beverage cup holder includes a beverage cup holder body having a light source and a vent port. The beverage cup holder also includes an ash cup insert including a vent port interface and an illumination ring. The ash cup insert optionally nests in the beverage cup holder body with the vent port interface in communication with the vent port and the illumination ring illuminated by the light source.

### TECHNICAL FIELD

This document relates generally to the motor vehicle equipment field and, more specifically, to a beverage cup holder that is convertible to a self-venting ash tray, to an apparatus for converting an illuminated beverage cup holder in a motor vehicle console into an ash tray and a method for the converting of a beverage cup holder in a motor vehicle console into an ash tray.

### BACKGROUND

Many individuals smoke while driving or riding in a motor vehicle. Thus, a need exists for the improved handling of smoke and the reduction of or elimination of odors produced by cigarette, cigar, or pipe waste including ashes and butts held in the ash tray of the motor vehicle. This document relates to a new and improved apparatus for converting a beverage cup holder into an ash tray as well as to a beverage cup holder that is convertible to a self-venting ash tray and a related method.

### SUMMARY

In accordance with the purposes and benefits described herein, an apparatus is provided for converting an illuminated beverage cup holder in a motor vehicle console into an ash tray. That apparatus comprises an ash cup insert that is received in the illuminated beverage cup holder. The ash cup insert includes an illumination ring illuminated by a light source in the illuminated beverage cup holder. In one possible embodiment, the ash cup insert further includes a hinged lid that is outlined by the illumination ring.

In accordance with an additional aspect, a beverage cup holder is provided that is convertible to a self-venting ash tray. That beverage cup holder comprises a beverage cup holder body including a light source and a vent port, and an ash cup insert including a vent port interface and an illumination ring. The ash cup insert optionally nests in the beverage cup holder with the vent port interface in communication with the vent port and the illumination ring illuminated by the light source.

In one possible embodiment, the illumination ring is made from a rylene die material.

The ash cup insert may include a cylindrical body and the illumination ring may be a sleeve received over the cylindrical body. That cylindrical body includes a closed bottom and an open top. A hinged lid is carried on the cylindrical body and closes the open top. In one particularly useful embodiment, the hinged lid is outlined by a top edge of the illumination ring which also identifies the open top of the ash cup insert when the lid is opened.

In one possible embodiment, the beverage cup holder further includes a vent line extending from the vent port to ambient outside of the motor vehicle equipped with the beverage cup holder. Further, the beverage cup holder body further includes a vent port door displaceable between a home position closing the vent port and an open position opening the vent port. In one possible embodiment, the vent port door slides on a track. In another possible embodiment, the vent port door pivots about a pivot. In either of these embodiments, the vent cup interface includes a feature to engage and open the vent port door when the ash cup is fully nested in the cup holder.

In accordance with yet another aspect, a method is provided of converting a beverage cup holder in a motor vehicle console into a ash tray. That method may be broadly described as comprising the steps of inserting an ash cup insert into the beverage cup holder and aligning a light source in the beverage cup holder with an illumination ring carried on the ash cup insert. In one possible embodiment, the method further includes providing the ash cup insert with a lid. In one possible embodiment, the method further includes outlining the lid with the illumination ring. In one possible embodiment, the method includes providing the beverage cup holder with a vent port and the ash cup insert with a vent port interface. Further, the method may include aligning the vent port interface with the vent port so as to draw smoke from the ash cup insert through the vent port interface and the vent port to ambient outside of the motor vehicle.

Still further, a motor vehicle equipped with the beverage cup holder described herein is also provided.

In the following description, there are shown and described several preferred embodiments of (a) the apparatus for converting an illuminated beverage cup holder in a motor vehicle console into an ash tray as well as (b) a beverage cup holder convertible to a self-venting ash tray. As it should be realized, the conversion apparatus and beverage cup holder are capable of other, different embodiments and their several details are capable of modification in various, obvious aspects all without departing from the conversion apparatus and beverage cup holder as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the conversion apparatus and beverage cup holder and together with the description serve to explain certain principles thereof. In the drawing figures:

FIG. 1 is an exploded perspective view illustrating both the apparatus for converting the illuminated beverage cup holder in a motor vehicle console into an ash tray and one embodiment of the beverage cup holder that is convertible to a self-venting ash tray.

FIG. 2 is a schematic cross-sectional view of the beverage cup holder with the ash cup insert held therein for converting the beverage cup holder into an ash tray.

FIGS. 3a and 3b are schematic views illustrating a pivoting vent port door for closing the vent port in the beverage cup holder when the ash cup insert is not in use and opening the vent port in the beverage cup holder when the ash cup insert is in use and is properly and fully nested in the beverage cup holder so as to convert the beverage cup holder into a self-venting ash tray. FIG. 3a illustrates the door in a closed position. FIG. 3b illustrates the door in an open position upon engagement with a door opening feature carried on the ash cup insert.

FIGS. 4a and 4b are schematic views illustrating a sliding vent port door for closing the vent port in the beverage cup holder when the ash cup insert is not in use and opening the vent port in the beverage cup holder when the ash cup insert is in use and is properly and fully nested in the beverage cup holder so as to convert the beverage cup holder into a self-venting ash tray. FIG. 4a illustrates the door in a closed position. FIG. 4b illustrates the door in an open position upon engagement with a door opening feature carried on the ash cup insert.

Reference will now be made in detail to the present preferred embodiments of the conversion apparatus and beverage cup holder, examples of which are illustrated in the accompanying drawing figures.

### DETAILED DESCRIPTION

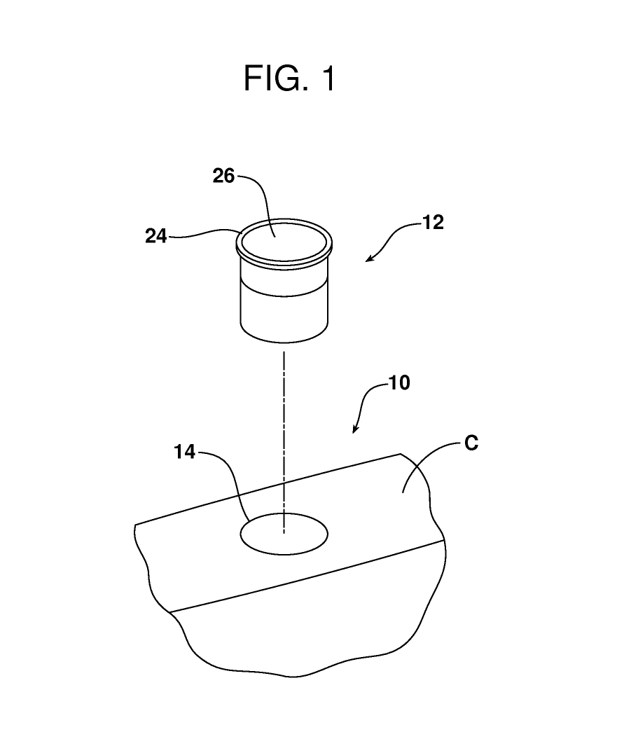

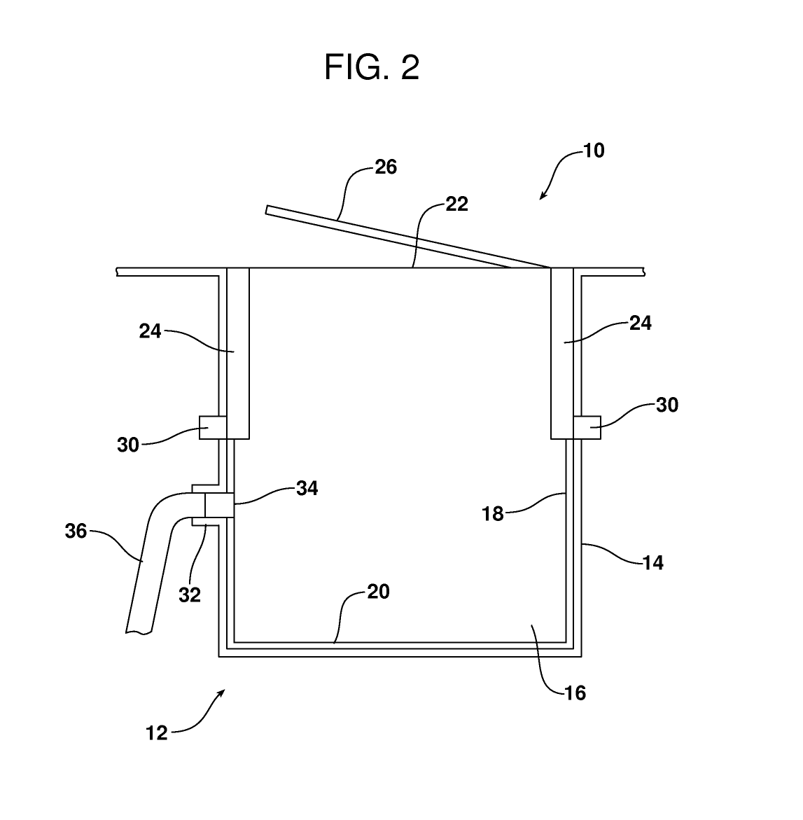

Reference is now made to FIGS. 1 and 2 illustrating the beverage cup holder 10 that may be converted to a self-venting ash tray by means of the apparatus 12 for converting an illuminated beverage cup holder in a motor vehicle console C into an ash tray. More specifically, that apparatus 12 comprises an ash cup insert that is received in the illuminated beverage cup body 14.

Specifically, the ash cup insert 12 includes a cylindrical body 16 having a sidewall 18, a closed bottom end 20 and an open top end 22. The apparatus/ash cup insert 12 further includes an illumination ring 24. In the illustrated embodiment, the illumination ring 24 comprises a sleeve that is received over the cylindrical body 16. In one possible embodiment, the illumination ring 24 is made from a rylene dye material of a type that is known to glow when subjected to even a relatively small amount of light from a light source in the beverage cup holder 10.

As further illustrated, the apparatus/ash cup insert 12 also includes a hinged lid 26 carried on the body 16. In a closed position, the hinged lid 26 closes the open top end 22 of the body 16. When the lid is in an open position, the top end 22 is open to provide ready access to the ash chamber 28 formed by the sidewall 18 and closed bottom end 20 of the cylindrical body 16. As should be appreciated from the drawing figures, the hinged lid 26 is concentrically received within the top edge of the illumination ring 24. Thus, the illumination ring 24 provides light that clearly identifies the position of the ash cup insert 12 and, more particularly, the open top end 22 when the hinged lid 26 is opened. Thus, one may quickly and easily find the ash cup insert 12 in low-light ambient conditions or darkness for the depositing of ashes and butts from cigarettes and cigars.

As best illustrated in FIG. 2, the beverage cup holder body 14 includes a light source 30 and a vent port 32. The light source 30 may comprise a series of light-emitting diodes. Alternatively, the light source 30 may comprise a light pipe directing light from a remote light source (not shown) positioned at another part of the motor vehicle console C. When the apparatus/ash cup insert 12 is fully inserted into the beverage cup holder body 14 to convert the beverage cup holder 10 into an ash tray, the illumination ring 24 is aligned with and juxtaposed to the light source 30 so that illumination from the light source will illuminate or cause the illumination ring of rylene dye to glow.

An alternative embodiment of the beverage cup holder 10 may also include a self-venting feature. Thus, as best illustrated in FIG. 2, the beverage cup holder body 14 may include a vent port 32. The apparatus/ash cup insert 12 may also be equipped with a cooperating vent port interface 34. When the apparatus/ash cup insert 12 is fully inserted and nested in the beverage cup holder body 14, the vent port interface 34 is provided in communication with the vent port 32. A vent line 36 runs from the vent port 32 to ambient outside the passenger cabin of the motor vehicle. As a result, air currents generated by vehicle movement serve to draw smoke and odors from the ash cup insert 12 through the vent port interface 34, vent port 32 and vent line 36 into the ambient environment thereby reducing or eliminating smoking odors from the interior of the motor vehicle.

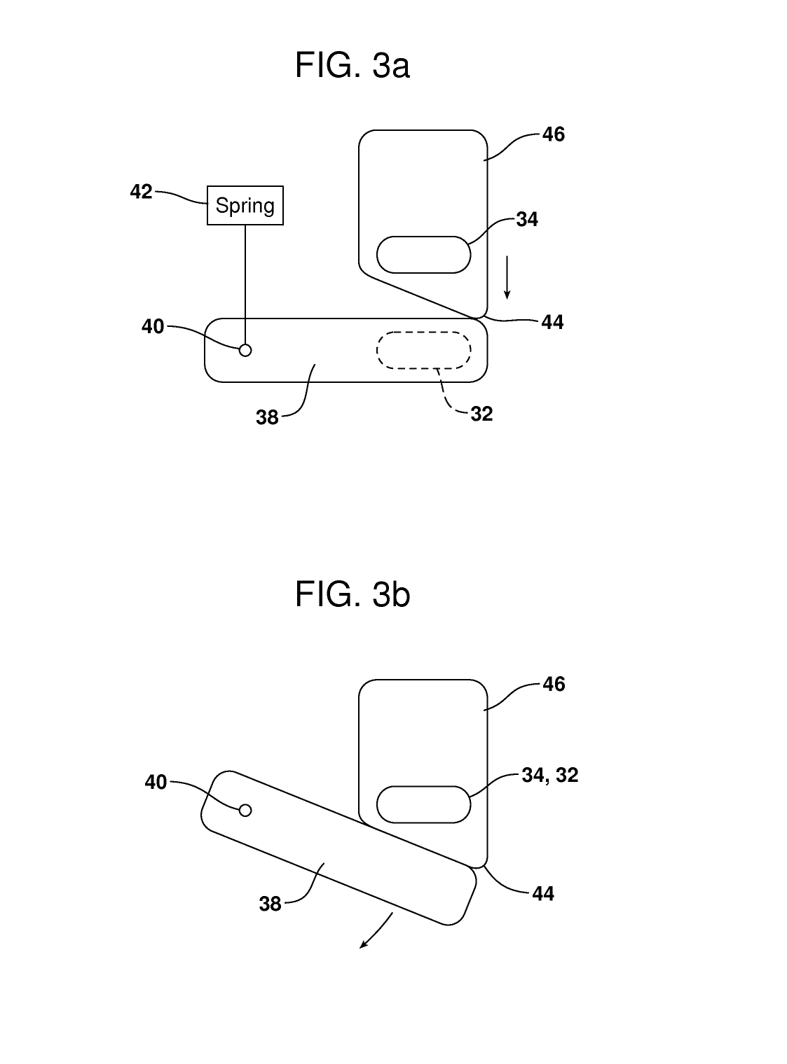

As illustrated in FIGS. 3a and 3b, the beverage cup holder body 14 may also include a vent port door 38 that pivots about a pivot pin 40 and is displaceable between a home position closing the vent port 32 (see FIG. 3a) and an open position opening the vent port 32 (see FIG. 3b). More specifically, a spring 42, such as a torsion spring, biases the door 40 into the closed position. When the ash cup insert 12 is pushed downwardly into the beverage cup holder body 14 (note action arrow in FIG. 3a) and the ash cup insert is fully seated, a feature 44 on the ash cup insert engages the door 40 and displaces the door 38 into the open position. The vent port interface 34 in the feature 44 is then aligned with the vent port 32 so that smoke and odor in the ash cup insert 12 are drawn through the vent port interface 46, the vent port 32 and the vent line 36 to ambient.

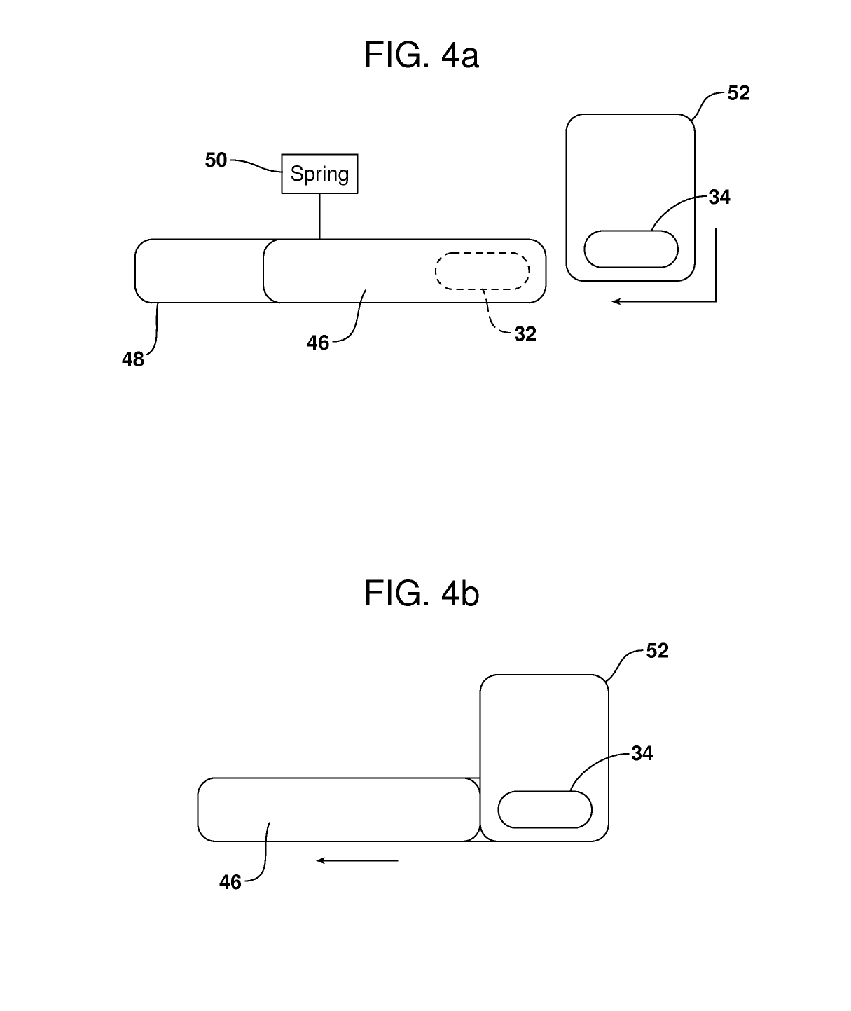

FIGS. 4a and 4b illustrate an alternative embodiment incorporating a sliding door 46 that moves along a track 48. FIG. 4a illustrates the door 46 in a closed position overlying the vent port 32. A spring 50, such as a compression spring, normally biases the door 46 into the closed position. When the ash cup insert 12 is pushed downwardly into the beverage cup holder body 14 and twisted (note action arrow in FIG. 4a), a feature 52 on the ash cup insert engages the door 46 and displaces the door into the open position illustrated in FIG. 4b. The vent port interface 34 in the feature 52 is then aligned with the vent port 32 so that smoke and odor in the ash cup insert 12 are drawn to ambient. Thus, for either embodiment, it should be appreciated that the vent port 32 is closed in the absence of the ash cup insert 12: that is, at all times when the beverage cup holder 10 is functioning as a beverage cup holder and not as an ash tray.

As should be further appreciated, a method is provided for converting a beverage cup holder 10 in a motor vehicle console C into an ash tray. That method may be broadly described as comprising the step of inserting an ash cup insert 12 into the beverage cup holder body 14 and aligning a light source 30 in the beverage cup holder 14 with an illumination ring 24 carried on the ash cup insert 12. Advantageously, this allows the existing light within the beverage cup holder 14 to illuminate the ring 24 of the optional ash cup body so that the illumination ring 24 outlines the opening 22 at the top of the cylindrical body 16 of the ash cup insert 12.

In one possible embodiment, the method further includes providing the ash cup insert 12 with a lid 26 and outlining the lid with the illumination ring 24.

In yet another embodiment, the method includes providing the beverage cup holder 14 with a vent port 38 and the ash tray insert 12 with a vent port interface 34. Further the method includes aligning the vent port interface 34 with the vent port 32 and drawing smoke and odor from the ash cup insert 12 through the vent port interface 34 and the vent port 32 along a vent line 36 to ambient outside of the motor vehicle.

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled.

What is claimed:

1. An apparatus for converting an illuminated beverage cup holder in a motor vehicle console into an ash tray, comprising:
an ash cup insert received in a body of said illuminated beverage cup holder, said ash cup insert including an illumination ring illuminated by a light source in said illuminated beverage cup holder.

2. The apparatus of claim 1, wherein said illumination ring is made from a rylene dye material.

3. The apparatus of claim 1, wherein said ash cup insert further includes a hinged lid outlined by said illumination ring.

4. A beverage cup holder convertible to a self-venting ash tray, comprising:
a beverage cup holder body including a light source and a vent port;
an ash cup insert including a vent port interface and an illumination ring, said ash cup insert optionally nesting in said beverage cup holder body with said vent port interface in communication with said vent port and said illumination ring illuminated by said light source.

5. The beverage cup holder of claim 4, wherein said illumination ring is made from a rylene dye material.

6. The beverage cup holder of claim 5, wherein said ash cup insert includes a cylindrical body and said illumination ring is a sleeve received over said cylindrical body.

7. The beverage cup holder of claim 6, wherein said cylindrical body includes a closed bottom and an open top.

8. The beverage cup holder of claim 7, further including a hinged lid carried on said cylindrical body and closing said open top when in a first position.

9. The beverage cup holder of claim 8, wherein said hinged lid is outlined by a top edge of said illumination ring.

10. The beverage cup holder of claim 9, further including a vent line extending from said vent port to ambient outside of a motor vehicle passenger cabin equipped with said beverage cup holder.

11. The beverage cup holder of claim 10, wherein said beverage cup holder body further includes a vent port door displaceable between a home position closing said vent port and an open position opening said vent port.

12. The beverage cup holder of claim 11, wherein said vent port door slides along a track.

13. The beverage cup holder of claim 11, wherein said vent port door pivots about a pivot.

14. The beverage cup holder of claim 11, wherein said vent port interface includes a feature to engage and open said vent port door when said ash cup is fully nested in said cup holder.

15. A method of converting a beverage cup holder in a motor vehicle console into an ash tray, comprising:
inserting an ash tray insert into a body of said beverage cup holder; and
aligning a light source in said beverage cup holder with an illumination ring carried on said ash cup insert.

16. The method of claim 15, including providing said ash cup insert with a lid.

17. The method of claim 16, including outlining said lid with said illumination ring.

18. The method of claim 17, including providing said beverage cup holder with a vent port and said ash tray insert with a vent port interface.

19. The method of claim 18, including aligning said vent port interface with said vent port and drawing smoke and odor from said ash cup insert through said vent port interface and said vent port to ambient outside of said motor vehicle.

20. A motor vehicle equipped with the beverage cup holder of claim 4.
